(19) United States
(12) Patent Application Publication
(10) Pub. No.: US 2024/0345828 A1
(43) Pub. Date: Oct. 17, 2024

(54) FIRMWARE UPDATE METHOD, ELECTRONIC DEVICE PERFORMING SAME, AND CHARGING DEVICE

(71) Applicant: Samsung Electronics Co., Ltd., Suwon-si (KR)

(72) Inventors: Seungho LEE, Suwon-si (KR); Hongsup LEE, Suwon-si (KR); Jin SAGONG, Suwon-si (KR); Youngjin OH, Suwon-si (KR)

(21) Appl. No.: 18/752,040

(22) Filed: Jun. 24, 2024

Related U.S. Application Data
(63) Continuation of application No. PCT/KR2022/015949, filed on Oct. 19, 2022.

(30) Foreign Application Priority Data
Dec. 24, 2021 (KR) 10-2021-0178628
Mar. 3, 2022 (KR) 10-2022-0027622

(51) Int. Cl. G06F 8/65

(52) U.S. Cl. CPC G06F 8/65

(57) ABSTRACT

A firmware update method, an electronic device performing same, and a charging device are provided. An electronic device includes a battery, memory storing one or more computer programs, a communication module for establishing communication with a user terminal and a charging device, and one or more processors communicatively coupled to the battery, the memory, and the communication moule, wherein the one or more computer programs further include computer-executable instructions that, when executed by the one or more processors individually or collectively, cause the electronic device to transmit, to the charging device via the communication module, a set time to initiate a firmware upgrade and a flag that causes firmware of at least one of the electronic device or the charging device to be updated at the set time, receive, via the communication module, the flag from the charging device at the set time, and update firmware of at least one of the electronic device or the charging device by using firmware data that is received from the user terminal according to the flag and stored in the memory.

### CROSS-REFERENCE TO RELATED APPLICATION(S)

This application is a continuation application, claiming priority under § 365(c), of an International application No. PCT/KR2022/015949, filed on Oct. 19, 2022, which is based on and claims the benefit of a Korean patent application number 10-2021-0187628, filed on Dec. 24, 2021, in the Korean Intellectual Property Office, and of a Korean patent application number 10-2022-0027622, filed on Mar. 3, 2022, in the Korean Intellectual Property Office, the disclosure of each of which is incorporated by reference herein in its entirety.

### BACKGROUND

### 1. Field

The disclosure relates to a firmware update method and an electronic device and charging device for performing the method. More particularly, the disclosure relates to the firmware update method and the electronic device and charging device for performing the method, in which an electronic device not including a real time clock (RTC) updates firmware without a user's input and a wake-up at a set time through an external device.

### 2. Description of Related Art

An electronic device, such as a true wireless stereo (TWS), is often left for a long time when used once in terms of use time. When power is fully charged, the TWS may reduce power consumption by turning power off after a certain time and may increase a state of charge (SOC) when a user starts using it.

To update the firmware or software (SW) of the electronic device, a cradle, which is a charging device of the electronic device, may be opened and the electronic device may be paired with a user terminal such that the firmware or the SW may be updated with the consent of the user.

The above information is presented as background information only to assist with an understanding of the disclosure. No determination has been made, and no assertion is made, as to whether any of the above might be applicable as prior art with regard to the disclosure.

### SUMMARY

When an electronic device updates firmware or software (SW) while being paired with a user terminal, a user may not use the electronic device during a time spent for the update. Since a real time clock (RTC) is often not readily mounted to the electronic device, such as a true wireless stereo (TWS), it may be difficult for the user to set an update time for the firmware or the SW and update the firmware or the SW at the time set by the user.

Aspects of the disclosure are to address at least the above-mentioned problems and/or disadvantages and to provide at least the advantages described below. Accordingly, an aspect of the disclosure is to provide a firmware update method and an electronic device and a charging device, in which the firmware of an electronic device and a charging device which do not include an RTC may be updated by using a charging device that is connected electrically to an electronic device and includes an RTC such that the charging device charges the electronic device.

Another aspect of the disclosure is to provide a firmware update method and an electronic device and a charging device, in which an electronic device not including an RTC is woken up at a set time, and the firmware of the electronic device and a charging device is updated.

Additional aspects will be set forth in part in the description which follows and, in part, will be apparent from the description, or may be learned by practice of the presented embodiments.

In accordance with an aspect of the disclosure, an electronic device is provided. The electronic device includes a battery, memory storing one or more computer programs, a communication module configured to establish a connection for communication with a user terminal and a charging device, and one or more processors communicatively coupled to the battery, the memory, and the communication module, wherein the one or more computer programs include computer-executable instructions that, when executed by the one or more processors individually or collectively, cause the electronic device to transmit, to the charging device via the communication module, a set time to initiate a firmware upgrade and a flag that causes firmware of at least one of the electronic device or the charging device to be updated at the set time, receive, via the communication module, the flag from the charging device at the set time, and update firmware of at least one of the electronic device or the charging device by using firmware data that is received from the user terminal according to the flag and stored in the memory.

In accordance with another aspect of the disclosure, a charging device is provided. The charging device includes a communication module configured to establish a connection for communication with an electronic device, memory storing one or more computer programs, and one or more processors communicatively coupled to the communication module and the memory, wherein the one or more computer programs further include computer-executable instructions that, when executed by the one or more processors individually or collectively, cause the charging device to receive, from the electronic device via the communication module, a set time to initiate a firmware upgrade and a flag that causes firmware of at least one of the electronic device or the charging device to be updated at the set time, and determine whether the set time has been reached and transmit the flag to the electronic device at the set time.

In accordance with another aspect of the disclosure, a firmware update method is provided. The firmware update method includes transmitting, to a charging device, a set time and a flag that causes firmware of at least one of an electronic device or the charging device to be updated at the set time, receiving the flag from the charging device at the set time, and updating firmware of at least one of the electronic device or the charging device by using firmware data that is received from a user terminal according to the flag and stored in memory.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include transmitting, to a charging device, a set time and a flag that causes firmware of at least one of an electronic device or the charging device to be updated at the set time, receiving the flag from the charging device at the set time, and updating firmware of at least one of the electronic device or the charging device by using firmware data that is received from a user terminal according to the flag and stored in memory.

According to various embodiments disclosed herein, the firmware of an electronic device that does not include an RTC and is unable to be woken up by itself may be updated.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment, according to an embodiment of the disclosure;

FIG. 2 is a schematic block diagram illustrating an electronic device and a charging device according to an embodiment of the disclosure;

FIG. 3 is a diagram illustrating an operation of the electronic device updating the firmware of an electronic device or a charging device according to an embodiment of the disclosure;

FIG. 4 is another diagram illustrating an operation of the electronic device updating the firmware of an electronic device or a charging device according to an embodiment of the disclosure;

FIG. 5 is a diagram illustrating an operation of the charging device transmitting a flag to an electronic device at a set time according to an embodiment of the disclosure;

FIG. 6 is a diagram illustrating an operation of the charging device transmitting a flag to an electronic device at a set time and updating firmware by using received firmware data according to an embodiment of the disclosure; and

FIG. 7 is a diagram illustrating an operation of updating the firmware of the electronic device and the charging device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

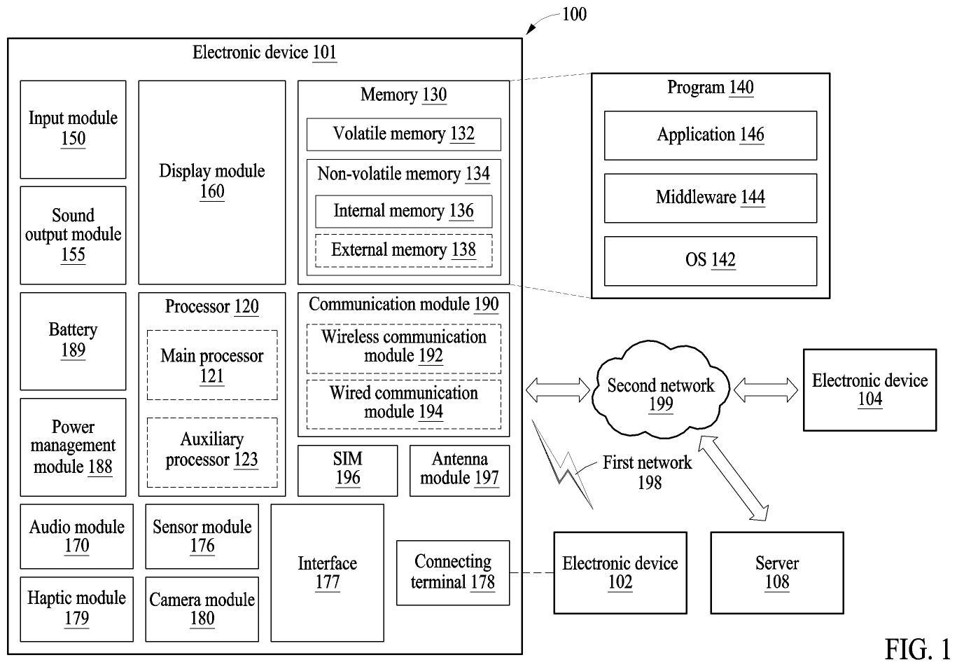

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computations. According to an embodiment, as at least a part of data processing or computations, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specifically for artificial intelligence model processing. An artificial intelligence model may be generated by machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a deep Q-network or a combination of two or more thereof but is not limited thereto. The artificial intelligence model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, or the projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an embodiment, the connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to one embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device, for example, the electronic device 104, via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC on a first surface (e.g., the bottom surface) of the PCB, or adjacent to the first surface of the PCB and capable of supporting a designated high-frequency band (e.g., a mmWave band), and a plurality of antennas (e.g., array antennas) arranged on a second surface (e.g., the top or a side surface) of the PCB, or adjacent to the second surface of the PCB and capable of transmitting or receiving signals of the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device (e.g., the electronic device 104) via the server 108 coupled with the second network 199. Each of the external electronic devices (e.g., the electronic device 102 or 104) may be a device of the same type as or a different type from the electronic device 101. According to an embodiment, all or some of operations to be executed by the electronic device 101 may be executed by one or more external electronic devices (e.g., the electronic devices 102 and 104 and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or service. The one or more external electronic devices receiving the request may perform the at least part of the function or service, or an additional function or an additional service related to the request and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra low-latency services using, e.g., distributed computing or MEC. In an embodiment, the external electronic device (e.g., the electronic device 104) may include an Internet-of-things (IoT) device. The server 108 may be an intelligent server using machine learning and/or a neural network. According to an embodiment, the external electronic device (e.g., the electronic device 104) or the server 108 may be included in the second network 199. The electronic device 101 may be applied to intelligent services (e.g., smart home, smart city, smart car, or healthcare) based on 5G communication technology or IoT-related technology.

For example, the electronic device 101 may be wireless earbuds. The electronic device 101 may be a true wireless stereo (TWS) device and may output sound from the sound output module 155 using data received from the connected external electronic device 102. The electronic device 101 may transmit voice received from the external electronic device 102 through the input module 150.

For example, the electronic device 101 may be connected electrically to the external electronic device 102 (e.g., a cradle or a wireless charger). For example, when the electronic device 101 is paired with a user terminal (not illustrated) and connected electrically to a cradle or a wireless charger, pairing with the user terminal may be terminated and the battery 189 may be charged using power supplied from the cradle or the wireless charger.

For example, a charging device (e.g., the electronic device 102), such as a cradle or a wireless charger, may include a cover. The cover may open or close an accommodation part in which the electronic device 101 is combined with the charging device and placed depending on an operation. For example, the charging device may provide a signal to the electronic device 101 to wake the electronic device 101 up in response to an operation of the cover. For example, when the electronic device 101 is fully charged, the electronic device 101 and/or the charging device may be set to a sleep mode. When the cover is open, the charging device may wake up the electronic device 101.

For example, the charging device may receive a charge state of the battery 189 from the electronic device 101. The charging device may display a battery 189 charge state of the electronic device 101 or a battery charge state of the charging device by using a display module (e.g., the display module 160), a lamp, or the like.

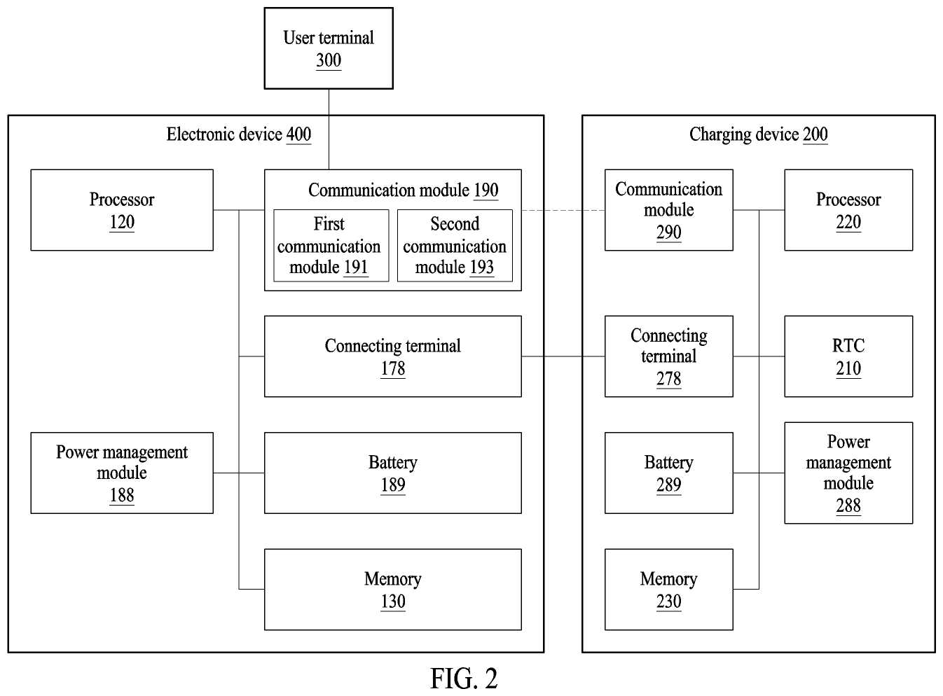

FIG. 2 is a schematic block diagram illustrating an electronic device 400 (e.g., the electronic device 102 or 104 of FIG. 1) and a charging device 200 (e.g., the electronic device 102 or 104 of FIG. 1) according to an embodiment of the disclosure.

Referring to FIG. 2, the electronic device 400 according to various embodiments may include the processor 120, the communication module 190, the connecting terminal 178, the power management module 188, the battery 189, or the memory 130. The charging device 200 according to various embodiments may include a processor 220 (e.g., the processor 120 of FIG. 1), a communication module 290 (e.g., the communication module 190 of FIG. 1), a connecting terminal 278 (e.g., the connecting terminal 178 of FIG. 1), a real time clock (RTC) 210, a battery 289 (e.g., the battery 189 of FIG. 1), a power management module 288 (e.g., the power management module 188 of FIG. 1), or memory 230 (e.g., the memory 130 of FIG. 1).

For example, the processor 120 of the electronic device 400 may be connected electrically to at least one of the communication module 190, the power management module 188, the battery 189, or the memory 130. For example, the processor 120 may transmit and/or receive data to and/or from the charging device 200 through the connecting terminal 178 by using the communication module 190. The processor 120 may charge the battery 189 by using the power management module 188.

Referring to FIG. 2, the electronic device 400 may be connected for communication with at least one of a user terminal 300 (e.g., the electronic device 102 or 104 of FIG. 1) or the charging device 200. For example, the electronic device 400 may be connected wirelessly for communication with the user terminal 300 by using the communication module 190. For example, according to a communication method, such as Bluetooth (BT), the electronic device 400 may be connected wirelessly for communication with the user terminal 300. The electronic device 400 may be connected by wire for communication with the communication module 290 of the charging device 200 by using the communication module 190 of the electronic device 400.

For example, the communication module 190 of the electronic device 400 may include a first communication module 191 (e.g., the wireless communication module 192 of FIG. 1) or a second communication module 193 (e.g., the wired communication module 194 of FIG. 1). For example, the electronic device 400 may be connected wirelessly for communication with the user terminal 300 by using the first communication module 191. For example, the electronic device 400 may be connected by wire for communication with the charging device 200 by using the second communication module 193.

For example, the electronic device 400 may identify a time set for updating firmware or a flag that causes the firmware to be updated. For example, the electronic device 400 may receive a time set by a user from the user terminal 300. The electronic device 400 may receive, from the user terminal 300, a flag that causes the firmware of the electronic device 400 and/or the charging device 200 to be updated. The electronic device 400 may receive, from the user terminal 300, firmware data of the electronic device 400 and/or the charging device 200. The electronic device 400 may store the received firmware data in the memory 130.

For example, the flag may be set for performing instructions corresponding to the flag. For example, when the electronic device 400 receives a flag for transmitting a current state of charge of the battery 189 to the user terminal 300 or the charging device 200, the electronic device 400 may transmit the state of charge of the battery 189 to the user terminal 300 or the charging device 200 by using the communication module 190.

In another example, when receiving a flag that causes the firmware of the electronic device 400 to be updated, the electronic device 400 may update the firmware by using the firmware data, which is stored in the memory 130, of the electronic device 400. For example, when receiving a flag that causes the firmware of the charging device 200 to be updated, the electronic device 400 may transmit the firmware data, which is stored in the memory 130, of the charging device 200 to the charging device 200.

For example, the flag may be a series of set operations for performing the instructions corresponding to the flag. For example, when the electronic device 400 receives the flag for transmitting the current state of charge of the battery 189 to the user terminal 300 or the charging device 200, the electronic device 400 may perform an operation of identifying the current state of charge of the battery 189 and an operation of transmitting the identified current state of charge of the battery 189 to the user terminal 300 or the charging device 200.

In another example, when receiving a flag that causes the firmware of the electronic device 400 and/or the charging device 200 to be updated at a set time, the electronic device 400 may perform an operation of transmitting the set time and the flag to the charging device 200 and an operation of updating the firmware of the electronic device 400 and/or the charging device 200 at the set time. The set time may be, for example, a certain time or cycle to determine whether there is firmware to be updated. For example, when the set time is a 1-hour cycle, the electronic device 400 may hourly determine whether there is firmware to be updated.

For example, the electronic device 400 may be connected by wire for communication with the charging device 200. For example, the connecting terminal 178 of the electronic device 400 may be connected to the connecting terminal 278 of the charging device 200. The electronic device 400 may be connected for communication with the charging device 200 through the connecting terminal 178. For example, the connecting terminal 278 of the charging device 200 may have a form corresponding to that of the connecting terminal 178 of the electronic device 400, and the connecting terminal 278 of the charging device 200 may be connected electrically to the connecting terminal 178 of the electronic device 400.

For example, the communication module 190 of the electronic device 400 may transmit and/or receive data by wire to and/or from the charging device 200 by using a power line communication (PLC) protocol. The electronic device 400 may transmit or receive data to or from the charging device 200 through the connecting terminal 178. For example, the electronic device 400 may transmit data to the charging device 200 by using a set instruction.

For example, the connecting terminal 178 of the electronic device 400 may receive power through the connecting terminal 278 of the charging device 200. For example, the charging device 200 may charge the battery 189 through the connecting terminal 178 with power supplied from the battery 289 of the charging device 200.

For example, the electronic device 400 may be wireless earbuds and the charging device 200 may be a wireless charger. The electronic device 400 may be connected electrically to the charging device 200 through the connecting terminal 178 or 278. The charging device 200 may supply power to the electronic device 400 through the connecting terminal 178 or 278. The electronic device 400 may be connected for communication with the charging device 200 through the connecting terminal 178 or 278.

For example, the power management module 188 may charge the battery 189 by using power input from the charging device 200 through the connecting terminal 178. The power management module 188 may identify a state of charge of the battery 189.

For example, the electronic device 400 may transmit the set time and/or the flag to the charging device 200. The electronic device 400 may transmit the set time and/or the flag to the charging device 200 through the connecting terminal 178 by using the communication module 190. For example, the flag may be a flag that causes the firmware of the electronic device 400 and/or the charging device 200 to be updated at the set time.

For example, the electronic device 400 may receive the flag from the charging device 200 at the set time. For example, the flag received by the electronic device 400 may be substantially the same as the flag transmitted by the electronic device 400 to the charging device 200. The electronic device 400, according to the flag, by using the firmware data stored in the memory 130, may update the firmware of the electronic device 400 and/or the charging device 200. For example, when the received flag is the flag that causes the firmware of the electronic device 400 to be updated, the electronic device 400 may update the firmware of the electronic device 400 by using the firmware data, which is stored in the memory 130, of the electronic device 400. For example, when the received flag is the flag that causes the firmware of the charging device 200 to be updated, the electronic device 400 may transmit the firmware data, which is stored in the memory 130, of the charging device 200 to the charging device 200. For example, the firmware data may include a binary of the charging device 200.

As described above, the electronic device 400 may receive the set time and the flag from the charging device 200 at the set time and may update the firmware of the electronic device 400 and/or the charging device 200 at the set time.

For example, the processor 220 of the charging device 200 may be connected electrically to at least one of the communication module 290, the power management module 288, the battery 289, the RTC 210, or the memory 230. For example, the processor 220 may transmit and receive data to and from the electronic device 400 through the connecting terminal 278 by using the communication module 290. The processor 220 may supply the power, which has been charged in the battery 189, to the electronic device 400 by using the power management module 288. The processor 220 may identify a current time by using the RTC 210 and may compare the current time with the set time.

The charging device 200 according to various embodiments may receive the set time and the flag from the electronic device 400. For example, the charging device 200 may receive the set time and the flag from the electronic device 400 by using the communication module 190 through the connecting terminal 278. For example, the charging device 200 may receive the set time and the flag from the electronic device 400 according to a set instruction. For example, the charging device 200 may receive the set time and the flag from the electronic device 400 connected electrically to the charging device 200.

For example, the flag received by the charging device 200 from the electronic device 400 may refer to an operation of determining whether it has reached the set time and an operation of transmitting, to the electronic device 400, the flag that causes the firmware of the electronic device 400 and/or the charging device 200 to be updated at the set time. For example, according to the received flag, the charging device 200 may perform the operation of determining whether a time identified in real time reaches the set time and the operation of transmitting, to the electronic device 400, the flag that causes the firmware of the electronic device 400 and/or the charging device 200 to be updated at the set time.

In another example, according to the flag received from the electronic device 400, the charging device 200 may perform the operation of determining whether a current time reaches the set time by setting itself to a wake-up mode for each set cycle from a sleep mode, an operation of transmitting, to the electronic device 400, a signal that sets the electronic device 400 to a wake-up mode, the operation of transmitting, to the electronic device 400, the flag that causes the firmware of the electronic device 400 and/or the charging device 200 to be updated at the set time.

For example, the charging device 200 may determine whether it has reached the set time received from the electronic device 400. The charging device 200 may set itself to a wake-up mode for each set cycle. The charging device 200 may determine whether it has reached the set time is the set time by using the number of wakeups for each set cycle.

For example, the charging device 200 may receive a time when receiving the flag from the electronic device 400. The charging device 200 may determine whether it has reached the set time by using the time when receiving the flag, the set cycle, and the number of wakeups. For example, if the time when receiving the flag is 18:00, the set time is 22:00 on the same day, and the set cycle is 10 minutes, the charging device 200 may determine that it has reached the set time when the number of wakeups is 24.

In another example, the charging device 200 may determine whether it has reached the set time by using a charging time, the time when receiving the flag, and the number of wakeups. For example, if the time when receiving the flag is 18:00, the set time is 22:00 on the same day, the set cycle is 10 minutes, and the charging time, which is a time during which the charging device 200 supplies power to the electronic device 400, is, for example, 1 hour, the charging device 200 may determine that it has reached the set time when the number of wakeups is 18.

In the example above, the electronic device 400 may transmit the current time to the charging device 200. For example, the electronic device 400 may be connected for communication with the user terminal 300 and may receive the current time in real time. When the electronic device 400 is connected electrically to the charging device 200, the electronic device 400 may transmit the current time, which has been received from the user terminal 300, to the charging device 200. For example, when the electronic device 400 is connected electrically to the charging device 200, a connection for communication with the user terminal 300 may be released.

In another example, the electronic device 400 may receive the current time in real time by being connected for communication with the user terminal 300 and may search for a connectable external electronic device (e.g., the electronic device 102 of FIG. 1) for each set cycle when the connection for communication with the user terminal 300 is released. The electronic device 400 may determine the current time by using a time when the connection for communication with the user terminal 300 is released, the set cycle, and the number of operations of searching for the external electronic device.

For example, if the time when the connection for communication with the user terminal 300 is 20:00, and the searching for the external electronic device is performed every minute and 60 times, the current time may be determined to be 21:00. The electronic device 400, when connected electrically to the charging device 200, may transmit the determined current time to the charging device 200.

In the example above, the electronic device 400 determining the current time by using the number of operations of searching for the external electronic device for each set cycle is described. However, the electronic device 400 may determine the current time by using the number of operations performed for each set cycle, besides the searching for the external electronic device, for example, the determining of a state of the battery 189 for each set cycle. As described above, the charging device 200 may determine whether it has reached the set time even when the charging device 200 does not include the RTC 210 for determining the current time in real time.

For example, the charging device 200 may supply power to the electronic device 400 and may charge the battery 189 of the electronic device 400. For example, by using the power management module 288, the charging device 200 may supply the power stored in the battery 289 to the electronic device 400 through the connecting terminal 278.

For example, the charging device 200 may receive the firmware data of the charging device 200 from the electronic device 400. For example, the charging device 200 may store the received firmware data in the memory 230. The charging device 200 may update the firmware of the charging device 200 by using the firmware data, stored in the memory 230, of the charging device 200.

For example, the charging device 200 may transmit the set time and/or the flag to the electronic device 400. The charging device 200 may identify time in real time. The charging device 200 may determine whether it has reached the set time by comparing the time identified in real time with the set time. The charging device 200 may transmit the set time and the flag to the electronic device 400 when the identified time reaches the set time. For example, the charging device 200 may determine that it is the set time and may transmit the flag to the electronic device 400 at the set time.

For example, the RTC 210 of the charging device 200 may identify the current time in real time. For example, the charging device 200 may compare the identified time with the set time by using the RTC 210 for each set cycle.

As described above, the charging device 200 may receive the set time and the flag from the electronic device 400 and may transmit the set time and the flag to the electronic device 400 at the set time. The charging device 200 may identify the current time by using the RTC 210, may compare the identified time with the set time, and may determine whether it has reached the set time. The charging device 200 may charge the battery 189 of the electronic device 400 by supplying power to the electronic device 400.

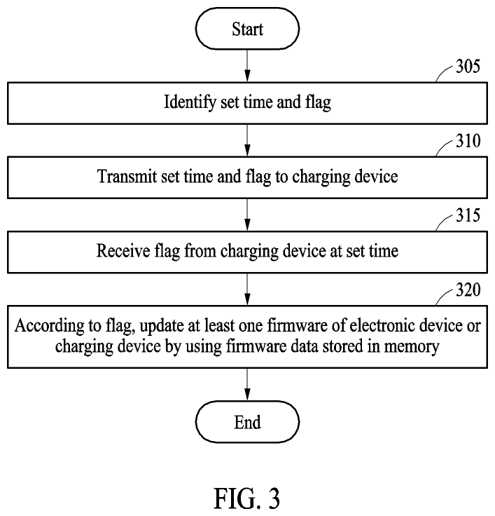

FIG. 3 is a diagram illustrating an operation of the electronic device updating the firmware of an electronic device (e.g., the electronic device 101 of FIG. 1 or the electronic device 400 of FIG. 2) or a charging device (e.g., the electronic device 102 of FIG. 1 or the charging device 200 of FIG. 2) according to an embodiment of the disclosure.

Referring to FIG. 3, the electronic device 400 according to various embodiments may identify a set time and a flag in operation 305. For example, the electronic device 400 may receive a time set by a user and/or a flag from a user terminal (e.g., the user terminal 300 of FIG. 2) connected through a communication module (e.g., the communication module 190 of FIG. 1). For example, the set time may be a time set for updating the firmware of the electronic device 400 and/or the charging device 200, and the flag may be a series of operations set for updating the firmware of the electronic device 400 and/or the charging device 200 at the set time.

For example, the electronic device 400 may transmit the set time and the flag to the charging device 200 in operation 310. For example, the electronic device 400 may be connected electrically to the charging device 200 through respective connecting terminals (e.g., the connecting terminals 178 and 278 of FIG. 2). For example, the electronic device 400 may transmit the set time and the flag to the charging device 200 through the connecting terminal 178 by using the communication module 190. In another example, the communication module 190 of the electronic device 400 may be connected wirelessly for communication with the communication module 190 of the charging device 200 and may transmit the set time and the flag wirelessly.

The electronic device 400 according to various embodiments may receive the flag from the charging device 200 at the set time in operation 315. For example, the electronic device 400 may receive the set time and/or the flag through the connecting terminal 178 by using the communication module 190.

The electronic device 400 according to various embodiments, in operation 320, according to the received flag, may update the firmware of the electronic device 400 and/or the charging device 200 by using the firmware data stored in the memory 130. The electronic device 400 may receive, from the user terminal 300, the firmware data and may store the firmware data in memory (e.g., the memory 130 of FIG. 1). For example, the firmware data may include at least one of data for updating the firmware of the electronic device 400 or data for updating the firmware of the charging device 200.

For example, the electronic device 400 may update the firmware based on at least one of an operating state, a state of charge, or a connection state of the electronic device 400 and the charging device 200. For example, the connection state may be a state of connection between the connecting terminal 178 of the electronic device 400 and the connecting terminal 278 of the charging device 200 by the electronic device 400 connected to the charging device 200. In this case, the connecting terminal 178 of the electronic device 400 may be connected electrically to the connecting terminal 278 of the charging device 200. For example, the state of charge may be a charged amount of a battery (e.g., the battery 189 or 289 of FIG. 2) of the electronic device 400 or the charging device 200. For example, the operating state may be an operation of pairing the electronic device 400 with the user terminal 300 and a state of a cover of the charging device 200 being open.

For example, in a state in which the electronic device 400 is not connected to the charging device 200, for example, when the electronic device 400 is deviated from the charging device 200 and in a use state, the electronic device 400 may not update firmware. In another example, the state of charge of the batteries 189 and 289 of the electronic device 400 and/or the charging device 200 is less than or equal to a set charged amount, the electronic device 400 may not update the firmware of the electronic device 400 and/or the charging device 200. For example, when the cover of the charging device 200 is open, the electronic device 400 may not update the firmware of the electronic device 400 and/or the charging device 200.

For example, the electronic device 400 may update the firmware of the electronic device 400 and/or the charging device 200 based on the user's state. For example, the electronic device 400 may receive the user's state from the user terminal 300. For example, the user terminal 300 may determine the user's state, for example, an exercise state, a sleep state, or the like. For example, the electronic device 400 may update the firmware of the electronic device 400 and/or the charging device 200 when the user's state received from the user terminal 300 is a sleep state or a rest state.

Operations 310 to 325 described above may be a series of operations performed by the electronic device 400 and/or the charging device 200 according to the flag identified in operation 305.

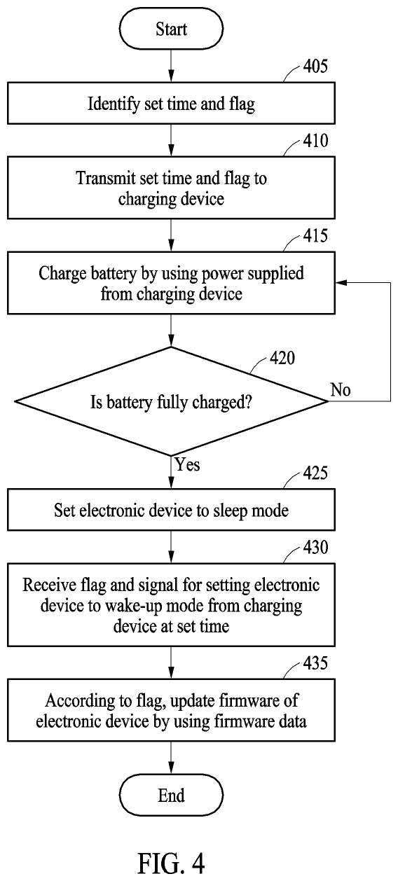

FIG. 4 is another diagram illustrating an operation of the electronic device updating the firmware of an electronic device (e.g., the electronic device 101 of FIG. 1 or the electronic device 400 of FIG. 2) or a charging device (e.g., the electronic device 102 of FIG. 1 or the charging device 200 of FIG. 2) according to an embodiment of the disclosure.

Referring to FIG. 4, the electronic device 400 according to various embodiments may identify a set time and a flag in operation 405 and may transmit the set time and the flag to the charging device 200 in operation 410.

The description of operations 305 and 310 may apply to operations 405 and 410 above, respectively, in substantially the same manner.

For example, the electronic device 400 may charge a battery (e.g., the battery 189 of FIG. 1) by using power supplied from the charging device 200 in operation 415. For example, the electronic device 400 may receive power from the charging device 200 through the connecting terminal 178 or 278.

For example, the electronic device 400 may determine whether the battery 189 of the electronic device 400 is fully charged in operation 420. For example, the electronic device 400 may identify the state of charge of the battery 189 by using a power management module (e.g., the power management module 188 of FIG. 1).

For example, the electronic device 400 may set the electronic device 400 to a sleep mode in operation 425 when the battery 189 of the electronic device 400 is fully charged in operation 420. For example, the sleep mode may be a mode, to reduce power consumption of the electronic device 400, of cutting off power supplied to components, for example, a processor (e.g., the processor 120 of FIG. 1), memory (e.g., the memory 130 of FIG. 1), or a communication module (e.g., the communication module 190 of FIG. 1), of the electronic device 400.

For example, the electronic device 400 may receive a flag and a signal that sets the electronic device 400 to a wake-up mode from the charging device 200 at a set time in operation 430. For example, the electronic device 400 may receive the signal that wakes the electronic device 400 up from the charging device 200 through the connecting terminal 178 at the set time. For example, the charging device 200 transmitting the signal that sets the electronic device 400 to a wake-up mode may refer to supplying power of which the size is greater than or equal to a set size to a connecting terminal (e.g., the connecting terminal 178 of FIG. 1).

According to an embodiment, the electronic device 400 may set the electronic device 400 from a sleep mode to a wake-up mode according to the signal, which is received from the charging device 200, that sets the electronic device 400 to a wake-up mode. For example, the electronic device 400 may supply power to components, for example, the processor 120, the memory 130, or the communication module 190, of the electronic device 400 in a wake-up mode.

For example, the flag that the electronic device 400 receives in operation 430 may be transmitted from the charging device 200 at the set time after determining whether the charging device 200 reaches the set time for each set cycle. For example, the charging device 200 may be set to a sleep mode in operation 425 in a manner substantially the same as that of the electronic device 400. The charging device 200 may determine whether a current time reaches the set time by setting the charging device 200 to a wake-up mode for each set cycle. When the charging device 200 determines that the current time reaches the set time, in operation 430, the electronic device 400 may receive, from the charging device 200, the flag and/or the signal that sets the electronic device 400 to a wake-up mode.

For example, the flag that the electronic device 400 receives in operation 430 may be operations that cause the firmware of the electronic device 400 and/or the charging device 200 to be updated at the set time. The electronic device 400 may update the firmware of the electronic device 400 and/or the charging device 200, like in operations 435 and/or 440 below, by receiving the current time from the charging device 200 and comparing the current time with the set time.

In another example, the flag that the electronic device 400 receives in operation 430 may be operations that cause the firmware of the electronic device 400 and/or the charging device 200 to be updated. The electronic device 400, according to the received flag, may update the firmware of the electronic device 400 and/or the charging device 200 like in operations 435 and/or 440 below.

The electronic device 400 according to various embodiments, in operation 435, according to the flag, may update the firmware of the electronic device 400. For example, the electronic device 400 may receive, from the user terminal 300, the firmware data of the electronic device 400 and/or the charging device 200 and may store it in the memory 130.

Operations 410 to 440 described above may be a series of operations performed by the electronic device 400 and/or the charging device 200 according to the flag identified in operation 405.

According to various embodiments, the electronic device 400 may operate according to an operation flow to which the order of some operations in the operation flowchart illustrated in FIG. 4 is altered. For example, as to operations 405, 410, and 415, the electronic device 400 may perform operations in the order of operations 405, 415, and 410 or the order of operations 415, 405, and 410.

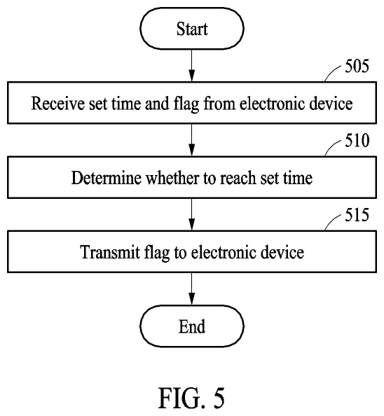

FIG. 5 is a diagram illustrating an operation of the charging device (e.g., the electronic device 102 of FIG. 1 or the charging device 200 of FIG. 2) transmitting a flag to an electronic device (e.g., the electronic device 101 of FIG. 1 or the electronic device 400 of FIG. 2) at a set time according to an embodiment of the disclosure.

Referring to FIG. 5, the charging device 200 according to various embodiments may receive the set time and a flag from the electronic device 400 in operation 505. For example, the charging device 200 may receive the set time and the flag from the electronic device 400 through a connecting terminal (e.g., the connecting terminal 278 of FIG. 2) by using a communication module (e.g., the communication module 290 of FIG. 2).

The charging device 200 according to various embodiments may determine whether the set time has been reached in operation 510. The charging device 200 may identify a current time in real time. The charging device 200 may determine whether it has reached the set time by comparing the identified time with the set time.

For example, the charging device 200 may transmit the flag to the electronic device 400 in operation 515 when determining, in operation 510, that it has reached the set time. For example, the charging device 200 may transmit the flag to the electronic device 400 through the connecting terminal 278 by using the communication module 290. For example, the flag that is transmitted or received in operations 505 and/or 520 may be operations that cause the firmware of the electronic device 400 and/or the charging device 200 to be updated at the set time.

For example, the charging device 200 may transmit the flag to the electronic device 400 based on at least one of an operating state, a state of charge, or a connection state of the electronic device 400 and the charging device 200. For example, the connection state may be an electrically connected state of the connecting terminal 178 of the electronic device 400 and the connecting terminal 278 of the charging device 200 by the electronic device 400 connected to the charging device 200. For example, the state of charge may be a charged amount of the battery 189 or 289 of the electronic device 400 or the charging device 200. For example, the operating state may be an operation of pairing the electronic device 400 with a user terminal (e.g., the user terminal 300 of FIG. 2) and a state of a cover of the charging device 200 being open.

For example, in a state in which the electronic device 400 is not connected to the charging device 200, for example, when the electronic device 400 is deviated from the charging device 200 and in a use state, the charging device 200 may not transmit the flag to the electronic device 400. In another example, the state of charge of the batteries 189 and 289 of the electronic device 400 and/or the charging device 200 is less than or equal to a set charged amount, the charging device 200 may not transmit the flag to the electronic device 400. For example, when a cover of the charging device 200 is open, the charging device 200 may not transmit the flag to the electronic device 400.

Operations 510 and 515 described above may be a series of operations performed by the charging device 200 according to the flag identified in operation 505.

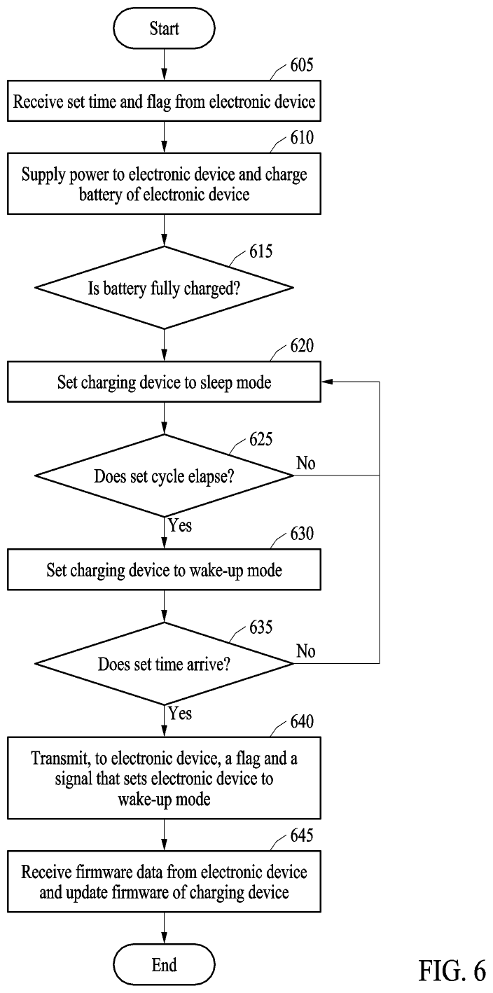

FIG. 6 is a diagram illustrating an operation of the charging device (e.g., the electronic device 102 of FIG. 1 or the charging device 200 of FIG. 2) transmitting a flag to an electronic device (e.g., the electronic device 101 of FIG. 1 or the electronic device 400 of FIG. 2) at a set time and updating firmware by using received firmware data according to an embodiment of the disclosure.

Referring to FIG. 6, the charging device 200 according to various embodiments may receive the set time and a flag from the electronic device 400 in operation 605. The description of operation 505 may apply to operation 605 in substantially the same manner.

For example, the charging device 200, in operation 610, may charge a battery (e.g., the battery 189 of FIG. 1) of the electronic device 400 by supplying power to the electronic device 400. For example, the charging device 200 may supply power to the electronic device 400 from a battery (e.g., the battery 289 of FIG. 2) of the charging device 200 through a connecting terminal (e.g., the connecting terminal 278 of FIG. 2). For example, the charging device 200 may include an input terminal for receiving power from the outside. The charging device 200 may charge the battery 289 of the charging device 200 by using the power received from the outside. The charging device 200 may supply power stored in the battery 289 to the electronic device 400. For example, the charging device 200 may determine whether the battery 189 of the electronic device 400 is fully charged in operation 615. For example, the charging device 200 may receive a state of charge of the battery 189 from the electronic device 400 and may determine whether the battery 189 of the electronic device 400 is fully charged.

For example, the charging device 200 may set the charging device 200 to a sleep mode in operation 620 when the battery 189 of the electronic device 400 is fully charged in operation 615. For example, the sleep mode may be a mode, to reduce power consumption of the charging device 200, of cutting off power supplied to components, for example, a processor (e.g., the processor 220 of FIG. 2), memory (e.g., the memory 230 of FIG. 2), or a communication module (e.g., the communication module 290 of FIG. 2), of the charging device 200.

For example, the charging device 200 may determine whether a set cycle has arrived in operation 625. For example, the charging device 200 may include an RTC (e.g., the RTC 210 of FIG. 2) that identifies time in real time. The charging device 200 may determine whether a set cycle has arrived by using the RTC 210. In another example, the charging device 200 may include a flip flop. The charging device 200 may determine whether the set cycle has arrived by using the flip flop.

For example, the charging device 200 may set the charging device 200 to a wake-up mode in operation 630 when determining, in operation 625, that the set cycle has arrived. For example, the charging device 200 may determine whether it has reached the set time in operation 635. For example, the charging device 200 may determine whether the current time reaches the set time by using the RTC 210.

For example, when the charging device 200 determines that it has reached the set time in operation 635, the charging device 200 may transmit, to the electronic device 400, a flag and a signal that sets the electronic device 400 to a wake-up mode in operation 640. For example, the charging device 200 transmitting the signal that sets the electronic device 400 to a wake-up mode may refer to supplying power of which the size is greater than or equal to a set size to a connecting terminal (e.g., the connecting terminal 178 of FIG. 1).

For example, the flag transmitted by the charging device 200 to the electronic device 400 in operation 635 may be substantially the same as the flag received by the electronic device 400 from the charging device 200 in operation 430 of FIG. 4.

The charging device 200 according to various embodiments, in operation 645, may receive firmware data from the electronic device 400 and may update the firmware of the charging device 200. For example, the charging device 200 may receive firmware data through a connecting terminal (e.g., the connecting terminal 278 of FIG. 2) by using the communication module 290. For example, the charging device 200 may update the firmware of the charging device 200 in operation 645 when transmitting, to the electronic device 400, in operation 640, a flag that causes the firmware of the charging device 200 to be updated or a flag that causes the firmware of the electronic device 400 to be updated.

Referring to operations 620 to 635 above, the charging device 200 according to various embodiments may determine whether it has reached the set time by using the RTC 210 for each cycle. The charging device 200, in a sleep mode, may determine whether it has reached the set time through wakeups for each set cycle. For example, like in operation 425 of FIG. 4, the electronic device 400 that has been fully charged, may be set to a sleep mode, and the charging device 200 may transmit, to the electronic device 400, a flag and a signal that sets the electronic device 400 to a wake-up mode at the set time. The charging device 200, by waking up the electronic device 400 at the set time and transmitting the flag, may wake up the electronic device 400, which does not include the RTC 210 and may not identify time in real time, at the set time and may cause the firmware to be updated at the set time.

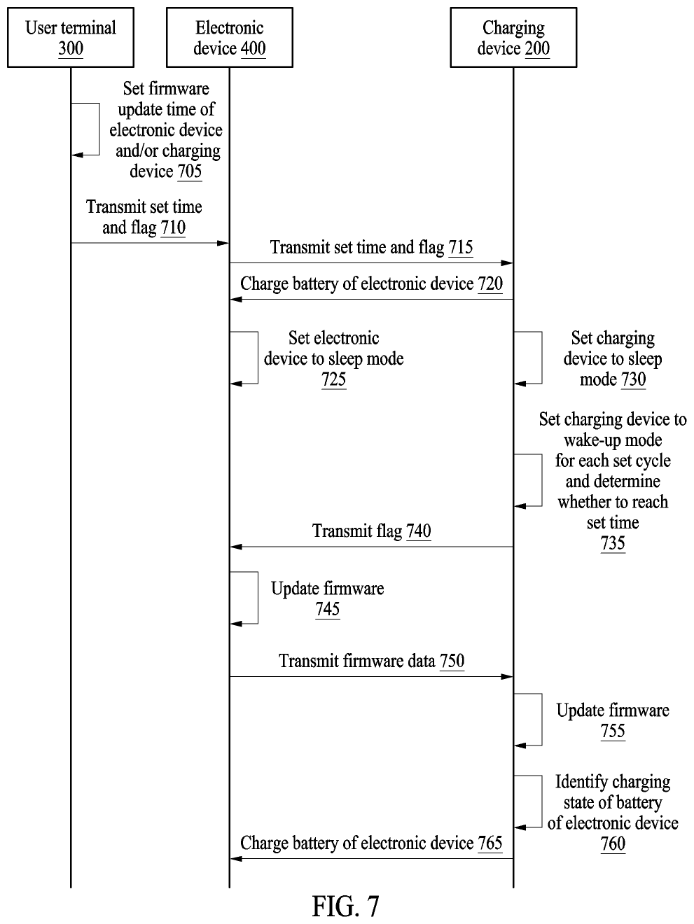

FIG. 7 is a diagram illustrating an operation of updating the firmware of the electronic device (e.g., the electronic device 101 of FIG. 1 or the electronic device 400 of FIG. 2) and the charging device (e.g., the charging device 200 of FIG. 2) according to an embodiment of the disclosure.

For example, the user terminal 300 (e.g., the user terminal 300 of FIG. 2) may set a firmware update time of the electronic device 400 and/or the charging device 200 in operation 705. For example, the user terminal 300 may set the firmware update time of the electronic device 400 and/or the charging device 200 based on an input received from a user.

For example, the electronic device 400 may receive a set time and a flag from the user terminal 300 in operation 705. For example, the electronic device 400 may be connected wirelessly for communication with the user terminal 300 and may receive the set time and the flag. For example, the electronic device 400 may receive, from the user terminal 300, the firmware data of the electronic device 400 and/or the charging device 200. For example, the electronic device 400 may store the received firmware data of the electronic device 400 and/or the charging device 200 in memory (e.g., the memory 130 of FIG. 2).

For example, the electronic device 400 may transmit the set time and the flag to the charging device 200 in operation 710. For example, the electronic device 400 may receive the set time and the flag from the user terminal 300. For example, the electronic device 400 may transmit the set time and the flag to the charging device 200 through a connecting terminal (e.g., the connecting terminal 178 of FIG. 1) in operation 715.

For example, the electronic device 400 may transmit the set time and the flag to the charging device 200 connected to the electronic device 400 by using a set instruction. For example, the electronic device 400 may be wireless earbuds, which are a TWS, and the charging device 200 may be a wireless charger, such as a cradle. The electronic device 400 may be connected to the charging device 200 and may charge a battery (e.g., the battery 189 of FIG. 1) of the electronic device 400. The connecting of the electronic device 400 to the charging device 200 may refer to the connecting terminal 178 of the electronic device 400 being connected electrically to a connecting terminal (e.g., the connecting terminal 278 of FIG. 2) of the charging device 200 for the charging of the battery 189 of the electronic device 400.

The charging device 200 according to various embodiments may charge the battery 189 of the electronic device 400 in operation 720. For example, the charging device 200 may supply power stored in the battery 289 of the charging device 200 to the electronic device 400 through the connecting terminal 178 or 278. The charging device 200 may charge the battery 189 by using the supplied power.

The electronic device 400 and the charging device 200 may be set to a sleep mode in operations 725 and 730, respectively. When the battery 189 of the electronic device 400 is fully charged, to reduce power consumption of the electronic device 400 and/or the charging device 200, the electronic device 400 and the charging device 200 may be set to a sleep mode.

The charging device 200 according to various embodiments, in operation 735, may set the charging device 200 to a wake-up mode for each set cycle and may determine whether it has reached the set time. For example, the charging device 200 may include an RTC (e.g., the RTC 210 of FIG. 2). The charging device 200 may compare an identified time with the set time by using the RTC 210 and may determine whether it has reached the set time.

For example, the charging device 200 may change a set cycle according to the difference between the identified time and the set time. For example, when an initially set cycle is 5 minutes, and the difference between the identified time and the set time is greater than or equal to 1 hour, the charging device 200 may perform a wakeup cyclically according to the initially set cycle and may compare the identified time with the set time. When the difference between the identified time and the set time is less than 1 hour, the charging device 200 may change the set cycle to 3 minutes and perform a wakeup according to the changed cycle and may compare the identified time with the set time. The example above is just an example of various embodiments, and a cycle may be set variously. For example, in the example above, when the difference between the identified time and the set time is less than 1 hour, the charging device 200 may change the set cycle to 1 minute.

For example, the charging device 200 may transmit the flag to the electronic device 400 in operation 740. For example, in operation 740, the charging device 200 may transmit at least one of the set time, a current time, or the flag to the electronic device 400 at the set time. For example, the flag may be operations set for updating firmware of at least one of the electronic device 400 or the charging device 200.

For example, in operation 745, the electronic device 400 may update the firmware of the electronic device 400 by using the firmware data, stored in memory (e.g., the memory 130 of FIG. 1), of the electronic device 400. For example, the electronic device 400 may transmit the firmware data of the charging device 200 to the charging device 200 in operation 750. For example, the charging device 200 may update the firmware of the charging device 200 by using the received firmware data in operation 755.

For example, the charging device 200 may identify a state of charge of the battery 189 of the electronic device 400 in operation 760. When the battery 189 of the electronic device 400 is not fully charged, the charging device 200 may charge the battery 189 of the electronic device 400 in operation 765.

According to various embodiments, an electronic device (e.g., the electronic device 101 of FIG. 1 or the electronic device 400 of FIG. 2) includes a battery (e.g., the battery 189 of FIG. 1), a processor (e.g., the processor 120 of FIG. 1), a communication module (e.g., the communication module 190 of FIG. 1) configured to establish a connection for communication with a user terminal (e.g., the user terminal 300 of FIG. 2) and a charging device (e.g., the electronic device 102 of FIG. 1 or the charging device 200 of FIG. 2) and memory (e.g., the memory 130 of FIG. 1) connected electrically to the processor 120 and configured to store instructions executable by the processor 120, in which the processor 120 is configured to, when the instructions are executed, transmit, to the charging device 200, a set time to initiate a firmware upgrade and a flag that causes firmware of at least one of the electronic device 400 or the charging device 200 to be updated at the set time, receive the flag from the charging device 200 at the set time, and update firmware of at least one of the electronic device 400 or the charging device 200 by using firmware data that is received from the user terminal 300 according to the flag and stored in the memory 130.

The processor 120 may determine whether the charging device 200 reaches the set time for each set cycle and may receive the flag from the charging device 200 at the set time.

The processor 120 may transmit the firmware data to the charging device 200 and may update the firmware of the charging device 200.

The processor 120 may transmit the set time and the flag to the charging device 200 connected to the electronic device 400 by using a set instruction.

The processor 120 may charge the battery 189 by using power supplied from the charging device 200, may set the electronic device 400 to a sleep mode when the battery 189 is fully charged, and may receive a signal that sets the electronic device 400 to a wake-up mode from the charging device 200 at the set time.

The processor 120 may update the firmware based on at least one of an operating state, a state of charge, and a connection state of the electronic device 400 and the charging device 200.

The electronic device 400 may be wireless earbuds and the charging device 200 may be a wireless charger.

According to various embodiments, a charging device (e.g., the electronic device 102 of FIG. 1 or the charging device 200 of FIG. 2) includes a processor (e.g., the processor 220 of FIG. 2), a communication module (e.g., the communication module 290 of FIG. 2) configured to establish a connection for communication with an electronic device 400, and memory 230 connected electrically to the processor 220 and configured to store instructions executable by the processor 220, in which the processor 220 is configured to, when the instructions are executed, receive, from the electronic device 400, a set time to initiate a firmware upgrade and a flag that causes firmware of at least one of the electronic device 400 or the charging device 200 to be updated at the set time and determine whether the set time has been reached and transmit the flag to the electronic device 400 at the set time.

The charging device 200 may further include the RTC 210 configured to identify time in real time, and the processor 220 may determine whether it has reached the set time by using the identified time through the RTC 210 for each set cycle.

The processor 220 may charge the battery 189 of the electronic device 400 by supplying power to the electronic device 400 and may set the charging device 200 to a sleep mode when the battery 189 of the electronic device 400 is fully charged, may determine whether the set time has been reached by setting the charging device 200 to a wake-up mode for each set cycle in the sleep mode, and may transmit a signal that sets the electronic device 400 to a wake-up mode to the electronic device 400 at the set time.

The processor 220 may receive firmware data from the electronic device 400 and update firmware.

The processor 220 may receive the set time and the flag according to a set instruction from the electronic device 400 connected to the charging device 200.

The processor 220 may transmit the flag to the electronic device 400 based on at least one of an operating state, a state of charge, and a connection state of the electronic device 400 and the charging device 200.

According to various embodiments, a firmware update method includes transmitting, to a charging device (e.g., the electronic device 102 of FIG. 1 or the charging device 200 of FIG. 2), a set time and a flag that causes firmware of at least one of an electronic device (e.g., the electronic device 101 of FIG. 1 or the electronic device 400 of FIG. 2) or the charging device 200 to be updated at the set time, receiving the flag from the charging device 200 at the set time, and updating firmware of at least one of the electronic device 400 or the charging device 200 by using firmware data that is received from a user terminal according to the flag and stored in the memory 130.

The receiving of the flag may include determining whether the charging device 200 reaches the set time for each set cycle and receiving the flag from the charging device 200 at the set time.

The updating of the firmware may include transmitting the firmware data to the charging device 200 and updating the firmware of the charging device 200.

The transmitting to the charging device 200 may include transmitting the set time and the flag to the charging device 200 connected to the electronic device 400 by using a set instruction.

The firmware update method further includes charging the battery 189 by using power supplied from the charging device 200 and setting the electronic device 400 to a sleep mode when the battery 189 is fully charged, and the receiving of the flag may include receiving a signal that sets the electronic device 400 to a wake-up mode from the charging device 200 at the set time.

The updating of the firmware may include updating the firmware based on at least one of an operating state, a state of charge, and a connection state of the electronic device 400 and the charging device 200.

The electronic devices according to various embodiments may be various types of electronic devices. The electronic device may include, for example, a portable communication device (e.g., a smartphone), a computer device, a portable multimedia device, a portable medical device, a camera, a wearable device, or a home appliance device. According to an embodiment, the electronic device is not limited to those described above.

It should be understood that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101 or 400). For example, a processor (e.g., the processor 120) of the machine (e.g., the electronic device 101 or 400) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to an embodiment, the integrated component may still perform one or more functions of each of the components in the same or similar manner as they are performed by a corresponding one among the components before the integration. According to an embodiment, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a battery;
memory storing one or more computer programs;
a communication module configured to establish a connection for communication with a user terminal and a charging device; and
one or more processors communicatively coupled to the battery, the memory, and the communication modules,
wherein the one or more computer programs include computer-executable instructions that, when executed by the one or more processors individually or collectively, cause the electronic device to:
transmit, to the charging device via the communication module, a set time to initiate a firmware upgrade and a flag that causes firmware of at least one of the electronic device or the charging device to be updated at the set time,
receive, via the communication module, the flag from the charging device at the set time, and
update firmware of at least one of the electronic device or the charging device by using firmware data that is received from the user terminal according to the flag and stored in the memory.

2. The electronic device of claim 1, wherein the one or more computer programs further include computer-executable instructions that, when executed by the one or more processors individually or collectively, cause the electronic device to:
determine whether the charging device reaches the set time for each set cycle; and
receive the flag from the charging device at the set time.

3. The electronic device of claim 1, wherein the one or more computer programs further include computer-executable instructions that, when executed by the one or more processors individually or collectively, cause the electronic device to:
transmit, via the communication module, the firmware data to the charging device; and
update the firmware of the charging device.

4. The electronic device of claim 1, wherein the one or more computer programs further include computer-executable instructions that, when executed by the one or more processors individually or collectively, cause the electronic device to:
transmit, via the communication module, the set time and the flag to the charging device connected electrically to the electronic device by using a set instruction.

5. The electronic device of claim 1, wherein the one or more computer programs further include computer-executable instructions that, when executed by the one or more processors individually or collectively, cause the electronic device to:
charge a battery by using power supplied by the charging device;
set the electronic device to a sleep mode when the battery is fully charged; and
receive, via the communication module, a signal that sets the electronic device to a wake-up mode from the charging device at the set time.

6. The electronic device of claim 1, wherein the one or more computer programs further include computer-executable instructions that, when executed by the one or more processors individually or collectively, cause the electronic device to:
update the firmware based on at least one of an operating state, a state of charge, and a connection state of the electronic device and the charging device.

7. The electronic device of claim 1,
wherein the electronic device is a pair of wireless earbuds, and
wherein the charging device is a wireless charger.

8. A charging device comprising:
a communication module configured to establish a connection for communication with an electronic device;
memory storing one or more computer programs; and
one or more processors communicatively coupled to the communication module and the memory,
wherein the one or more compute programs further include computer-executable instructions that, when executed by the one or more processors individually or collectively, cause the charging device to:
receive, from the electronic device via the communication module, a set time to initiate a firmware upgrade and a flag that causes firmware of at least one of the electronic device or the charging device to be updated at the set time, and
determine whether the set time has been reached and transmit the flag to the electronic device at the set time.

9. The charging device of claim 8, further comprising:
a real time clock (RTC) configured to identify a time in real time,
wherein the one or more computer programs further include computer-executable instructions that, when executed by the one or more processors individually or collectively, cause the charging device to determine whether the set time has been reached by using the identified time by using the RTC for each set cycle.

10. The charging device of claim 8, wherein the one or more computer programs further include computer-executable instructions that, when executed by the one or more processors individually or collectively, cause the charging device to:
charge a battery of the electronic device by supplying power to the electronic device and set the charging device to a sleep mode when the battery of the electronic device is fully charged;
determine whether the set time has been reached by setting the charging device to a wake-up mode for each set cycle in the sleep mode; and
transmit, via the communication module, a signal that sets the electronic device to a wake-up mode to the electronic device at the set time.

11. The charging device of claim 8, wherein the one or more computer programs further include computer-executable instructions that, when executed by the one or more processors individually or collectively, cause the charging device to:
receive, via the communication module, firmware data from the electronic device; and
update firmware.

12. The charging device of claim 8, wherein the one or more computer programs further include computer-executable instructions that, when executed by the one or more processors individually or collectively, cause the charging device to:
receive, via the communication module, the set time and the flag according to a set instruction from the electronic device connected electrically to the charging device.

13. The charging device of claim 8, wherein the one or more computer programs further include computer-executable instructions that, when executed by the one or more processors individually or collectively, cause the charging device to:
transmit, via the communication module, the flag to the electronic device based on at least one of an operating state, a state of charge, and a connection state of the electronic device and the charging device.

14. A firmware update method comprising:
transmitting, to a charging device, a set time and a flag that causes firmware of at least one of an electronic device or the charging device to be updated at the set time;
receiving the flag from the charging device at the set time; and
updating firmware of at least one of the electronic device or the charging device by using firmware data that is received from a user terminal according to the flag and stored in memory.

15. The firmware update method of claim 14, wherein the receiving the flag comprises:
determining whether the charging device reaches the set time for each set cycle and receiving the flag from the charging device at the set time.

16. The firmware update method of claim 14, wherein the updating the firmware comprises:
transmitting the firmware data to the charging device; and
updating the firmware of the charging device.

17. The firmware update method of claim 14, wherein the transmitting to the charging device comprises:
transmitting the set time and the flag to the charging device connected electrically to the electronic device by using a set instruction.

18. The firmware update method of claim 14, further comprising:
charging a battery by using a power supplied by the charging device; and
setting the electronic device to a sleep mode when the battery is fully charged,
wherein the receiving the flag comprises:
receiving a signal that sets the electronic device to a wake-up mode from the charging device at the set time.

19. The firmware update method of claim 14, wherein the updating the firmware comprises:
updating the firmware based on at least one of an operating state, a state of charge, and a connection state of the electronic device and the charging device.

20. One or more non-transitory computer-readable storage media storing one or more computer programs including computer-executable instructions that, when executed by one or more processors of an electronic device individually or collectively, cause the electronic device to perform operations, the operations comprising:
transmitting, to a charging device, a set time and a flag that causes firmware of at least one of an electronic device or the charging device to be updated at the set time;
receiving the flag from the charging device at the set time; and
updating firmware of at least one of the electronic device or the charging device by using firmware data that is received from a user terminal according to the flag and stored in memory.
